(19) United States
(12) Patent Application Publication
(10) Pub. No.: US 2026/0220299 A1
(43) Pub. Date: Jul. 30, 2026

(54) METHOD AND APPARATUS FOR PROCESSING LOG, DEVICE, AND PRODUCT

(71) Applicant: Beijing Zitiao Network Technology Co., Ltd., Beijing (CN)

(72) Inventors: Cong LIU, Beijing (CN); Hao ZHAO, Beijing (CN); Yonghao YI, Beijing (CN); Xing YAO, Beijing (CN)

(21) Appl. No.: 19/458,515

(22) Filed: Jan. 23, 2026

(30) Foreign Application Priority Data
Jan. 26, 2025 (WO) PCT/CN2025/075156

(51) Int. Cl. G06F 21/62

(52) U.S. Cl. CPC G06F 21/6245

(57) ABSTRACT

The present disclosure relates to a method and apparatus for processing a log, a device, and a product. The method includes classifying, in response to an event recorded into the log being triggered, the event as a target event category by a client. The method further includes acquiring, in response to determining that a log analysis task is triggered, a plurality of events with the target event category by the client. The method further includes generating event aggregation data by the client based on the plurality of events. Additionally, the method further includes uploading the event aggregation data to a server side from the client.

### CROSS-REFERENCE TO RELATED APPLICATION(S

This application claims priority to PCT Application No. PCT/CN2025/075156 filed in January 26, 2025, the disclosure of which is incorporated herein by reference in its entity.

### FIELD

The present disclosure relates to the field of data security, and more specifically, to a method and apparatus for processing a log, a device, and a product.

### BACKGROUND

With the rapid popularization of the mobile Internet, mobile applications have gradually integrated into daily lives of users, becoming indispensable tools. For example, video applications not only redefine entertainment ways of people but also provide crucial platforms for information dissemination, social interaction, and creative expression.

In the actual operation of the mobile applications, a large amount of log data is generated. The data covers information such as system states, operation records, application performance metrics, network communication records, as well as errors and exceptions. If the data is not properly collected and managed securely, it may lead to data leakage or misuse, posing a potential threat to overall data security.

### SUMMARY

In a first aspect of embodiments of the present disclosure, a method for processing a log is provided. The method includes classifying, in response to an event recorded into the log being triggered, the event as a target event category by a client. The method further includes acquiring, in response to determining that a log analysis task is triggered, a plurality of events with the target event category by the client. The method further includes generating event aggregation data by the client based on the plurality of events. Additionally, the method further includes uploading the event aggregation data to a server side from the client.

In a second aspect of the embodiments of the present disclosure, an apparatus for processing a log is provided. The apparatus includes an event classification module, configured to classify, in response to an event recorded into the log being triggered, the event as a target event category by a client. The apparatus further includes an event acquiring module, configured to acquire, in response to determining that a log analysis task is triggered, a plurality of events with the target event category by the client. The apparatus further includes an event aggregation module, configured to generate event aggregation data by the client based on the plurality of events. Additionally, the apparatus further includes an event upload module, configured to upload the event aggregation data to the server side from the client.

In a third aspect of the embodiments of the present disclosure, an electronic device is provided. The electronic device includes one or more processors; and a storage apparatus, configured to store one or more programs. The one or more programs, when executed by the one or more processors, cause the one or more processors to implement a method for processing a log. The method includes classifying, in response to an event recorded into the log being triggered, the event as a target event category by a client. The method further includes acquiring, in response to determining that a log analysis task is triggered, a plurality of events with the target event category by the client. The method further includes generating event aggregation data by the client based on the plurality of events. Additionally, the method further includes uploading the event aggregation data to a server side from the client.

In a fourth aspect of the embodiments of the present disclosure, a computer program product is provided. The computer program product is tangibly stored on a non-transitory computer-readable medium and includes a machine-executable instruction, and the machine-executable instruction, when executed, causes a machine to implement a method for processing a log. The method includes classifying, in response to an event recorded into the log being triggered, the event as a target event category by a client. The method further includes acquiring, in response to determining that a log analysis task is triggered, a plurality of events with the target event category by the client. The method further includes generating event aggregation data by the client based on the plurality of events. Additionally, the method further includes uploading the event aggregation data to a server side from the client.

The section SUMMARY is provided to introduce concept selection in a simplified form, which will be further described in the following specific implementations. The section SUMMARY is not intended to identify key or essential features of the subject claimed for protection, nor is it intended to limit the scope of the subject claimed for protection.

### BRIEF DESCRIPTION OF THE DRAWINGS

The above and other features, advantages, and aspects of various embodiments of the present disclosure will become more apparent in combination with the accompanying drawings and with reference to following detailed descriptions. In the accompanying drawings, the same or similar reference numerals denote the same or similar elements.

FIG. 1 illustrates a schematic diagram of an example environment where a plurality of embodiments of the present disclosure may be implemented;

FIG. 2 illustrates a flowchart of a method for processing a log according to some embodiments of the present disclosure;

FIG. 3 illustrates a schematic diagram of an example of a system for processing a log according to some embodiments of the present disclosure;

FIG. 4 illustrates a schematic diagram of an example for generating event aggregation data by using an event aggregator according to some embodiments of the present disclosure;

FIG. 5 illustrates a schematic diagram of an example of processing data by using a data filter according to some embodiments of the present disclosure;

FIG. 6 illustrates a block diagram of an apparatus for processing a log according to some embodiments of the present disclosure; and

FIG. 7 illustrates a block diagram of a device capable of implementing a plurality of embodiments of the present disclosure.

### DETAILED DESCRIPTION OF EMBODIMENTS

It should be understood that all user-related data involved in the technical solution should be acquired and used after user authorization, which means that in the technical solution, if personal information of a user needs to be used, explicit consent and authorization from the user are required before acquiring these data, otherwise, relevant data collection and use will not be carried out. It should also be understood that when the technical solution is implemented, relevant laws and regulations should be strictly followed in the process of data collection, use, and storage, and necessary technologies and measures should be taken to ensure the security of user data and the safe use of the data.

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

In the description of the embodiments of the present disclosure, the term "include" and similar terms thereof should be understood as open-ended inclusions, namely, "including but not limited to". The term "based on" should be understood as "at least partially based on". The term "an embodiment" or "this embodiment" should be understood as "at least one embodiment". The terms "first", "second", etc. may refer to different or identical objects, unless otherwise explicitly specified. Other explicit and implicit definitions may also be included below.

Mobile applications generate a large amount of log data during operation, including but not limited to system information, operation records, application performance data, network communication data, as well as error and exception data, etc. These logs are crucial tools for development engineers, operation and maintenance engineers, and data analysts to understand an application working state, troubleshoot issues, optimize performance, and make critical decisions. According to different requirements, the logs may record various events from application startup to runtime, such as user operations, background tasks, exception errors, and network requests. To analyze an operational state and the operation records of the application, application logs may be uploaded to a server side for a data analysis system to access.

Herein, the events refer to various operations or state changes triggered in an operation process of the application. For example, the events may include a user button click, page switching, video playback, a network request, an error exception, etc. Application engineers may preset event trigger conditions (also referred to as "tracking points") within application code. When the event trigger conditions are met, the application may capture the events and record data associated with the events. In the logs, the data associated with these events may include a specific type of target data (e.g., data associated with the user). If the data is not properly protected, data leakage or misuse may occur.

In some related art, all the logs are uploaded to the server side, and the target data in the logs at the server side is anonymized. However, there is still a potential risk of interception or leakage in a process of transmitting the data to the server side. In some related art, the application only collects a small amount of data that does not include the target data. Although the method can fully ensure data security, necessary performance monitoring and troubleshooting cannot be performed. In some other related art, the application allows the user to decide whether to upload data. However, the user may lack the relevant technical background and is likely to make inappropriate decisions, negatively impacting the user experience.

In view of this, an embodiment of the present disclosure provides a solution for processing a log. In the solution, if an event that is to be recorded to a log is triggered, a client may classify the event. When a log analysis task is triggered, the client may acquire a plurality of events with a target event category. Then, the client may perform an aggregation operation on the plurality of events to convert original log data into high-dimensionality event aggregation data (e.g., probabilistic statistics and trend analysis). Then, the client may upload the event aggregation data to the server side. Herein, the aggregation operation refers to generating the event aggregation data by performing operations such as statistical calculation and log analysis on the plurality of events. The event aggregation data may indicate statistical features of the plurality of aggregated events or log analysis results for the plurality of events.

Through the method, the probability that the event aggregation data includes the target data can be reduced, thereby reducing the target data uploaded to the server side, and improving data security. Additionally, the event aggregation data has a smaller size compared to original log data, and therefore by converting the original log data into the event aggregation data, the amount of the data that needs to be uploaded to the server side can be reduced, thereby saving network resources.

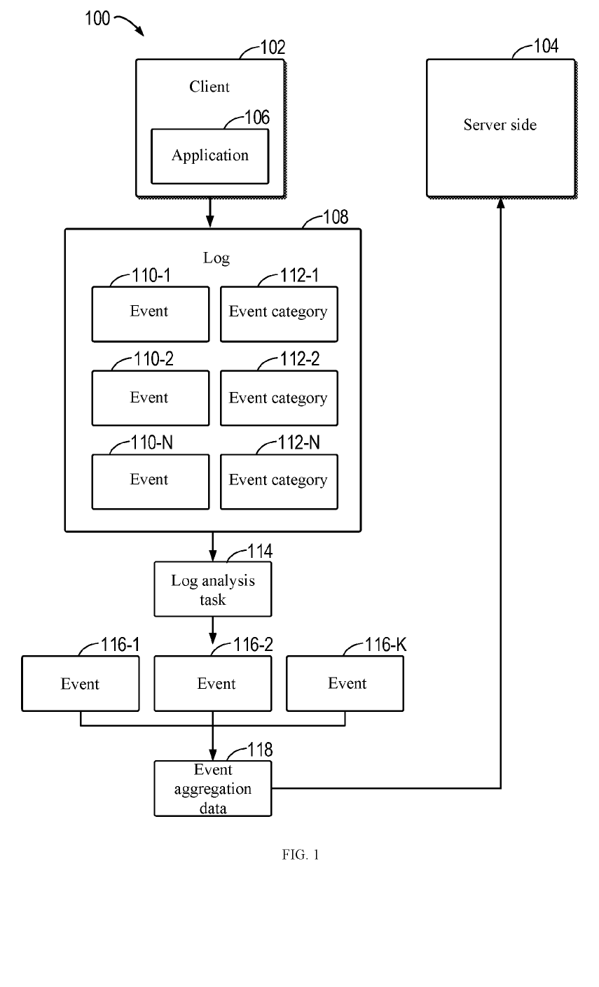

FIG. 1 illustrates a schematic diagram of an example environment 100 where a plurality of embodiments of the present disclosure may be implemented. As shown in FIG. 1, the environment 100 includes a client 102 and a server side 104. The client 102 may be any device that can run an application. For example, the client 102 may be a mobile phone, a smart wearable device, a tablet computer, a laptop computer, a desktop computer, an Internet-of-things device, or the like. The server side 104 may be any device with a processing capability or a computing capability. For example, the server side 104 may be a cloud server, a local server, a virtual server, a laptop computer, a desktop computer, or the like.

In the environment 100, an application 106 may run on the client 102, and the application 106 may be any application that generates a log in an operation process. For example, the application 106 may be a life service application, a video application, a music application, a social application, or the like. The log is a record file automatically generated in the operation process of the application, typically including application states, operations, error information, performance metrics, user behaviors, system events, etc. The log may assist development engineers, maintenance engineers, and data analysis engineers in understanding an application working state, troubleshooting issues, and making corresponding decisions.

In the environment 100, the application 106 may generate a log 108 in the operation process. The log 108 may include a plurality of events 110-1, 110-2, ..., and 110-N (collectively referred to as an event 110). For example, the event 110 may include normal operation events within the application (e.g., a page entry event, a page exit event, a button click event, and a form submission event), error events encountered in the operation process of the application (e.g., a crash event and an exception event), and events associated with application performance (e.g., an application launch event, a page load event, and an interface call event).

In the environment 100, when the event 110 is triggered, the client 102 may classify the event 110. For example, the client 102 may classify the event 110 based on a log analysis task associated with the event 110.As shown in FIG. 1, after being classified, the event 110 may have corresponding event categories 112-1, 112-2, ..., and 112-N (collectively referred to as an event category 112). The event category 112 may include a business event and an engineering event. The business event may be used to collect operation data related to a business, which assists a product operation team in analyzing historical operation records, optimizing functional design, and enhancing user experience. The engineering event may be used to collect data associated with system and application performance, which assists a technical team in locating issues, optimizing performance, and monitoring the operational state of the application.

In the environment 100, when the client 102 determines that a log analysis task 114 is triggered, a plurality of events 116-1, 116-2, ..., and 116-K (collectively referred to as an event 116) with a target event category may be acquired from the event 110. In some embodiments, the target event category may be a preset category. For example, the target event category may be the engineering event. Since the engineering event is typically used to troubleshoot faults or defects that occur in the application and optimize the application performance, aggregating these events at the client 102 (e.g., the probabilistic statistics and the trend analysis) and then uploading the events to the server side 104 will not significantly impact subsequent log analysis. In some embodiments, the target event category may be an event category set for the log analysis task 114.

In the environment 100, after determining the event 116 with the target event category, the client 102 may generate event aggregation data 118 based on the event 116.For example, the client 102 may perform aggregation or statistical analysis on the event 116 to generate the event aggregation data 118.For example, the client 102 may calculate statistical data such as the frequency of various events within the event 116, the distribution or average of performance metrics, and patterns of interactive behaviors, to reduce the target data included in event aggregation data 118. Then, the client 102 may upload the event aggregation data 118 to the server side 104 without uploading original data of the event 116.

Through the method, the probability that the event aggregation data 118 includes the target data can be reduced, thereby reducing the target data uploaded to the server side 104, and improving data security. Additionally, the event aggregation data 118 has a smaller size compared to the original data of the event 116, and therefore by converting the event 116 into the event aggregation data 118, the amount of the data that needs to be uploaded to the server side 104 can be reduced, thereby saving network resources.

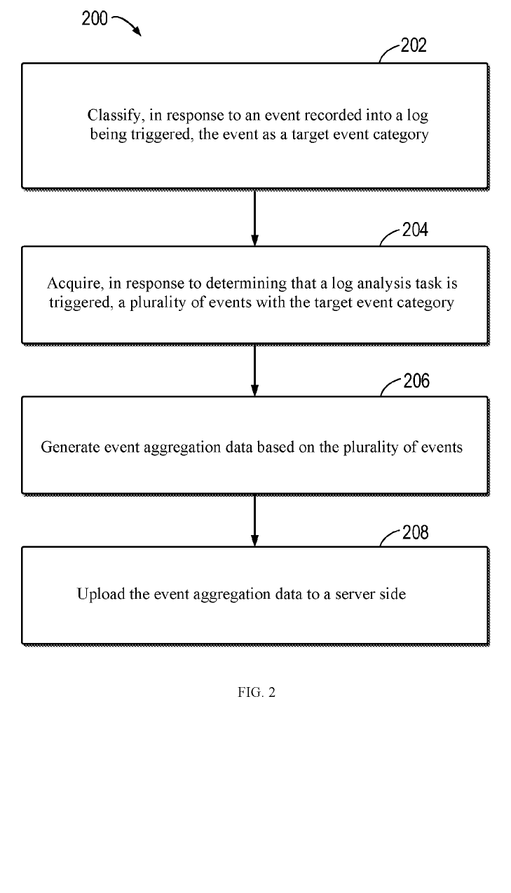

FIG. 2 illustrates a flowchart of a method 200 for processing a log according to some embodiments of the present disclosure. The method 200 may be performed by a client. For example, the method 200 may be performed by the client 102 in FIG. 1. As shown in FIG. 2, at a block 202, in response to an event recorded into a log being triggered, the client may classify the event as a target event category. For example, in the environment 100 shown in FIG. 1, when the event 110 is triggered, the client 102 may classify the event 110.For example, the client 102 may classify the event 110 based on a log analysis task associated with the event 110. After being classified, the event 110 may have a corresponding event category 112. In some embodiments, the target event category may be a preset category (e.g., an engineering event). In some embodiments, the target event category may be an event category set for the log analysis task 114.

At a block 204, in response to determining that the log analysis task is triggered, the client may acquire a plurality of events with a target event category. For example, in the environment 100 shown in FIG. 1, when the client 102 determines that the log analysis task 114 is triggered, a plurality of events 116 with a target event category may be acquired from the event 110.

At a block 206, the client may generate event aggregation data based on the plurality of events. For example, in the environment 100 shown in FIG. 1, the client 102 may generate the event aggregation data 118 based on the event 116. For example, the client 102 may perform aggregation or statistical analysis on the event 116 to generate the event aggregation data 118.For example, the client 102 may calculate statistical data such as the frequency of various events within the event 116, the distribution or average of performance metrics, and patterns of interactive behaviors, to reduce the target data included in event aggregation data 118.

At a block 208, the client may upload the event aggregation data to the server side. For example, in the environment 100 shown in FIG. 1, the client 102 may upload the event aggregation data 118 to the server side 104 without uploading the original data of the event 116.

Through the method, the probability that the event aggregation data includes the target data can be reduced, thereby reducing the target data uploaded to the server side, and improving data security. Additionally, the event aggregation data has a smaller size compared to original log data, and therefore by converting the original log data into the event aggregation data, the amount of the data that needs to be uploaded to the server side can be reduced, thereby saving network resources.

In some embodiments, the events are stored in a storage area located at the client. The storage area at the client is configured to store event streams based on a time series. The events stored in the storage area include trigger time of the events, types of the events, and the content of the events. When acquiring the plurality of events with the target event category, the client may acquire a plurality of events from the event streams stored in the storage area. In some embodiments, the client may determine a time difference between trigger time of an event and current time. In response to the time difference being greater than a predetermined retention time threshold, the client may delete the event from the storage area.

In some embodiments, the event is a first event, and after determining that the log analysis task is triggered, the client may determine that a second event is triggered. In response to determining that the trigger of the second event meets a preset trigger condition for the log analysis task, the client may determine that the log analysis task is triggered.

In some embodiments, when uploading the event aggregation data to the server side, in response to receiving a log upload request from the server side, the client may upload the event aggregation data to the server side, where the log upload request is sent by the server side to the client after receiving feedback from the user regarding a fault or defect.

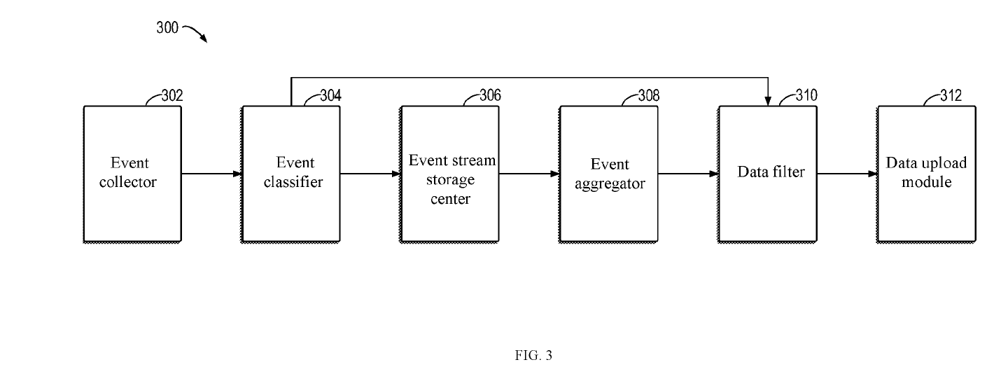

FIG. 3 illustrates a schematic diagram of an example 300 of a system for processing a log according to some embodiments of the present disclosure. The system shown in the example 300 may be deployed at a client. For example, the system may be deployed at the client 102 in FIG. 1 . The example 300 includes an event collector 302, an event classifier 304, an event stream storage center 306, an event aggregator 308, a data filter 310, and a data upload module 312.

The event collector 302 may be configured to collect various events triggered in the operation process of the application. For example, the event collector 302 may use an event tracking tool or a software development kit (SDK) to capture operational events triggered by the user within the application (e.g., a click event and a swipe event) and runtime events generated by the application (e.g., a launch event and an error event).The event collector 302 may also perform data structuration on the captured events (e.g., the events may be structured into a data structure in a JSON format ) to facilitate subsequent processing and storage of the events.

The event classifier 304 may be configured to classify the events, thereby allowing the client to execute various processing logics based on event categories. In some embodiments, the event classifier 304 may classify the events based on a preset mapping table between events and event categories. The event classifier 304 may classify the events into two event categories: one event category indicates that the original data of the events needs to be uploaded to the server side, and the other event category indicates that the events may be uploaded to the server side after being aggregated at the client. For example, in the preset mapping table, the event categories may include a business event that requires uploading the original data and an engineering event that may be aggregated. The business event may be used to collect operation data related to a business, which assists a product operation team in analyzing historical operation records, optimizing functional design, and enhancing user experience. For example, events clicking a "Like" button and submitting a comment may be mapped to the business event. The engineering event may be used to collect data associated with system and application performance, which assists a technical team in locating issues, optimizing performance, and monitoring the operational state of the application. For example, a page load event and an interface call failure event may be mapped to the engineering event.

After the event classifier 304 classifies the events, the events that are allowed to be further aggregated may be sent to the event stream storage center 306, and the events that require uploading the original data may be sent to the data filter 310.Through the method, different processing logics may be executed for the events with different event categories, thereby maintaining the accuracy of data analysis while reducing the target data within the data and improving data security.

The event stream storage center 306 may be configured to store event streams based on a time series. For example, the event stream storage center 306 may be implemented using an SQLite database. The events stored in the event stream storage center 306 may include trigger time of the events, types of the events, and the content of the events. The event stream storage center 306 may periodically check a time difference between the trigger time of the event and current time, and the time difference may indicate a duration that the event has been stored at the client. If an event has been stored at the client for longer than a preset time threshold (e.g., 24 hours), the event stream storage center 306 can automatically delete the event. Through the method, it can be ensured that the log data cannot be stored at the client for a long term, thereby improving data security.

The event aggregator 308 may be configured to acquire a plurality of events from the event stream storage center 306 when detecting a trigger event for the log analysis task, and perform an aggregation operation or statistical analysis on the plurality of acquired events, thereby generating event aggregation data. For example, the event aggregator 308 may acquire a preset trigger condition for the log analysis task, and trigger the log analysis task when determining that the captured event meets the trigger condition. For example, the log analysis task may be calculating statistical data such as the frequency of various events, the distribution or average of performance metrics, and patterns of interactive behaviors, to reduce the target data included in the calculated statistical data, thereby improving data security.

In some embodiments, the event aggregator 308 may store a plurality of log analysis tasks. Each log analysis task may be composed of a series of executable rules. These executable rules may be executed by a rule engine of the event aggregator 308. In some embodiments, the event aggregator 308 may determine the time of performing the aggregation operation in real time, and therefore the aggregation operation is performed when the client is idle, thereby reducing the impact on the normal operation of the application from the aggregation operation. In some embodiments, the log analysis task may be triggered by different events. In some embodiments, the probability of performing the log analysis task may be set for the trigger event, thereby reducing the frequency of performing the log analysis task, and saving processing resources.

The data filter 310 may be configured to perform a filtering operation on data from the event aggregator 308 and data from the event classifier 304, thereby desensitizing the data. The data filter 310 may recognize the target data from the data by using a machine learning model deployed at the client or a string processing rule stored at the client (e.g., a regular expression). In some embodiments, the data filter 310 may recognize the target data by combining the machine learning model and the string processing rule, thereby improving the accuracy of a recognition result. The recognized target data may be replaced by the data filter 310 with a preset value or may be deleted. Through the method, the target data may be filtered at the client before being uploaded to the server side, thereby reducing the possibility of data leakage in a network transmission process.

The data upload module 312 may be configured to use different control logics to upload the data to the server side according to data sources and requirements. In some embodiments, the data upload module 312 may save a log associated with a currently checked fault or detect at the client without uploading the log to the server side. Then, when determining that the user has provided a feedback for the fault or defect, the data upload module 312 may upload the associated log to the server side. Through the method, in the case of ensuring normal operation of the business, the uploaded data can be reduced, and the network resources are saved. In some embodiments, when a business requirement only indicates the need for the event aggregation data, the data upload module 312 may remove data such as a user identifier and a device identifier by using an anonymization or pseudonymization method, thereby further reducing user-associated data in the uploaded data.

In some embodiments, when the event aggregation data is generated based on the plurality of events, the client may acquire an aggregation strategy for the log analysis task. Then, the client may generate the event aggregation data by applying the aggregation strategy to the plurality of events. In some embodiments, the client may acquire the aggregation strategy for the log analysis task from the server side, where the aggregation strategy is configured by the user in real time at the server side. In some embodiments, the client may determine a resource utilization rate of the client. In response to determining that the resource utilization rate is less than a preset resource utilization rate threshold, the client may generate the event aggregation data based on the plurality of events.

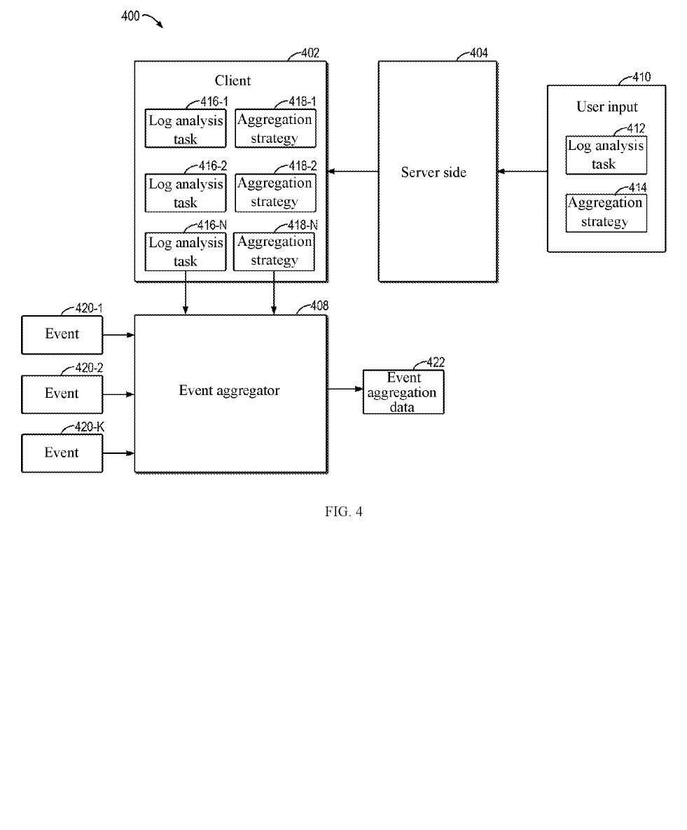

FIG. 4 illustrates a schematic diagram of an example 400 for generating event aggregation data by using an event aggregator according to some embodiments of the present disclosure. The example 400 includes a client 402 and a server side 404. An event aggregator 408 (e.g., the event aggregator 308 in FIG. 3) is deployed at the client 402.As shown in FIG. 4, log analysis tasks 416-1, 416-2, ..., and 416-N (collectively referred to as a log analysis task 416) and corresponding aggregation strategies 418-1, 418-2, ..., and 418-N (collectively referred to as an aggregation strategy 418) may be set at the client 402. Each aggregation strategy 418 may include a series of executable rules. When the log analysis task 416 is triggered, a rule engine of the event aggregator 408 may perform the corresponding aggregation strategy 418 to the plurality of events to generate the event aggregation data.

In the example 400, the server side 404 may receive a user input 410, and the user input 410 may include a log analysis task 412 and a corresponding aggregation strategy 414.The log analysis task 412 may be any one of the log analysis tasks 416 set at the client 402, or a new log analysis task. After receiving the user input 410, the server side 404 may send the log analysis task 412 and the aggregation strategy 414 to the client 402 in real time. After receiving the log analysis task 412 and the aggregation strategy 414, the client 402 may determine whether the set log analysis tasks 416 include the log analysis task 412.If the log analysis tasks 416 include the log analysis task 412, the client 402 may update the aggregation strategy for the log analysis task to the aggregation strategy 414.If the log analysis tasks 416 do not include the log analysis task 412, the log analysis task 412 and the aggregation strategy 414 may be set at the client 402.

For example, the client 402 may determine that the log analysis task 412 is the same as the log analysis task 416-N, the client 402 may update the aggregation strategy 418-N to the aggregation strategy 414. When the log analysis task 416-N is triggered, the event aggregator 408 may acquire an event stream including events 420-1, 420-2, ..., and 420-K (collectively referred to as an event 420) from an event stream storage center (e.g., the event stream storage center 306 in FIG. 3) and apply the aggregation strategy 418-N to the event stream to generate event aggregation data 422.

Through the method, without updating a code or a version of the client 402, the user can upload the log analysis task and the aggregation strategy at the client 402 in real time, thereby simplifying a process of adjusting the event aggregation operation, and improving data analysis flexibility and data security.

In some embodiments, when the event aggregation data is uploaded to the server side, the client may recognize a specific type of target data from the event aggregation data. Then, the client may generate processed event aggregation data by deleting or replacing the target data. Then, the client may upload the processed event aggregation data to the server side. In some embodiments, the client may recognize potential target data from the event aggregation data by using a natural language processing model. Then, the client may determine that the potential target data is a specific type of target data by using a regular expression.

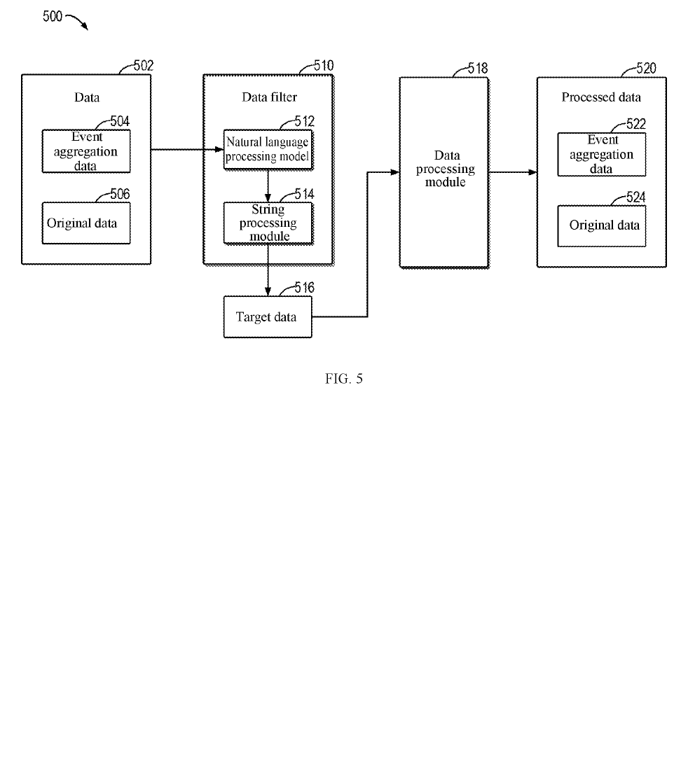

FIG. 5 illustrates a schematic diagram of an example 500 of processing data by using a data filter according to some embodiments of the present disclosure. As shown in FIG. 5, a data filter 510 (e.g., the data filter 310 in FIG. 3) and a data processing module 518 are deployed at a client. In the example 500, the data filter 510 may receive data 502 from an event classifier (e.g., the event classifier 304 in FIG. 3) or an event classifier (e.g., the event aggregator 308 in FIG. 3). The data 502 may include event aggregation data 504 (e.g., from the event aggregator), non-aggregated original data 506 (e.g., from the event classifier), or both.

In the example 500, to filter target data from the data 502 (e.g., data associated with the user), the data filter 510 may input the received data 502 into a natural language processing (NLP) model 512 to recognize the target data from the data 502.The natural language processing model is a machine learning model capable of performing a natural language understanding task, and processing and analyzing a text to complete various language tasks, such as text classification, sentiment analysis, machine translation, and a question-answering system. In the example 500, the natural language processing model 512 may be a language model fine-tuned for recognizing the target data based on a pre-trained language model (e.g., a BERT model). However, the natural language processing model 512 has a high recall rate and a low accuracy rate in the task of performing the target data. The recall rate and the accuracy rate are commonly used evaluation metrics in a classification task, where the recall rate represents a proportion of positive samples recognized by the model out of a total number of actual positive samples, and the accuracy rate represents a proportion of samples predicted as positive by the model that are actually positive.

In the example 500, based on characteristics of the natural language processing model 512, the target data recognized by the natural language processing model 512 may be determined as potential target data. Then, the potential target data may be input into a string processing module 514. The string processing module 514 may use a string processing rule (e.g., a regular expression) to recognize target data 516 from the potential target data. Compared to the natural language processing model 512, the string processing rule has a low recall rate and a high accuracy rate. Therefore, by recognizing the target data 516 from the data 502 in combination with the natural language processing model 512 and the string processing module 514, the comprehensiveness and accuracy of recognizing the target data can be improved.

After recognizing the target data 516 from the data 502, the data processing module 518 may replace the target data 516 with a preset value (e.g., a placeholder) or delete the target data 516 from the data 502, thereby generating processed data 520.The processed data 520 includes event aggregation data 522 or original data 524, and the target data from the event aggregation data 522 and the original data 524 has been replaced or deleted. Then, the processed data 520 may be uploaded to a server side through a data upload module (e.g., the data upload module 312 in FIG. 3).

Through the method, the data filter 510 may recognize the target data 516 from the data 502 in combination with the natural language processing model 512 and the string processing module 514, thereby improving the comprehensiveness and accuracy of recognizing the target data. By processing the target data 516, the probability of the uploaded data to the server side including the target data can be reduced, thereby reducing the risk of leakage of the target data in the network transmission process, and improving data security.

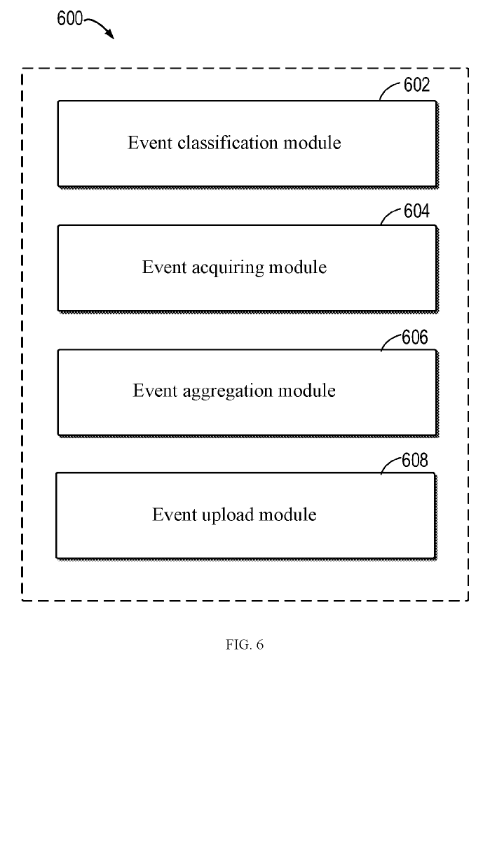

FIG. 6 illustrates a block diagram of an apparatus 600 for processing a log according to some embodiments of the present disclosure. As shown in FIG. 6, the apparatus 600 includes an event classification module 602, configured to classify, in response to an event recorded into the log being triggered, the event as a target event category by a client. The apparatus 600 further includes an event acquiring module 604, configured to acquire, in response to determining that a log analysis task is triggered, a plurality of events with the target event category by the client. The apparatus 600 further includes an event aggregation module 606, configured to generate event aggregation data by the client based on the plurality of events. Additionally, the apparatus 600 further includes an event upload module 608, configured to upload the event aggregation data to the server side from the client.

In some embodiments, the events are stored in a storage area located at the client. The storage area at the client is configured to store event streams based on a time series. The events stored in the storage area include trigger time of the events, types of the events, and the content of the events. The event acquiring module 604 includes: acquiring a plurality of events from the event streams stored in the storage area.

In some embodiments, the apparatus 600 further includes: a time difference determination module, configured to determine a time difference between trigger time of an event and current time; and a time difference comparison module, configured to delete the event from the storage area of the client in response to the time difference being greater than a predetermined retention time threshold.

In some embodiments, the event is a first event. The event aggregation module 606 includes: an event trigger module, configured to determine that a second event is triggered; and a task trigger module, configured to determine that the log analysis task is triggered in response to determining that the trigger of the second event meets a preset trigger condition for the log analysis task.

In some embodiments, the event aggregation module 606 includes: an aggregation strategy module, configured to acquire an aggregation strategy for the log analysis task; and an aggregation data generation module, configured to generate the event aggregation data by applying the aggregation strategy to the plurality of events.

In some embodiments, the aggregation strategy acquiring module includes: an aggregation strategy transmission module, configured to acquire the aggregation strategy for the log analysis task from the server side, where the aggregation strategy is configured by the user in real time at the server side.

In some embodiments, the event aggregation module 606 includes: a resource utilization rate determination module, configured to determine a resource utilization rate of the client; and a resource utilization rate use module, configured to generate the event aggregation data based on the plurality of events in response to determining that the resource utilization rate is less than a preset resource utilization rate threshold.

In some embodiments, the event upload module includes: a target data recognition module, configured to recognize a specific type of target data from the event aggregation data; a target data processing module, configured to delete or replace the target data to generate processed event aggregation data; and a data upload module, configured to upload the processed event aggregation data to the server side.

In some embodiments, the target data recognition module includes: a model use module, configured to use the natural language processing model to recognize potential target data from the event aggregation data; and a regular expression use module, configured to use a regular expression to determine that the potential target data is the specific type of target data.

In some embodiments, the event upload module 608 includes: an upload request receiving module, configured to upload, in response to receiving a log upload request from the server side, the event aggregation data to the server side, where the log upload request is sent by the server side to the client after receiving feedback from the user regarding a fault or defect.

It should be understood that by using the apparatus 600 in the present disclosure, at least one of the many advantages capable of being implemented in the method or the process described above may be achieved. Through the method, the probability that the event aggregation data includes the target data can be reduced, thereby reducing the target data uploaded to the server side, and improving data security. Additionally, the event aggregation data has a smaller size compared to original log data, and therefore by converting the original log data into the event aggregation data, the amount of the data that needs to be uploaded to the server side can be reduced, thereby saving network resources.

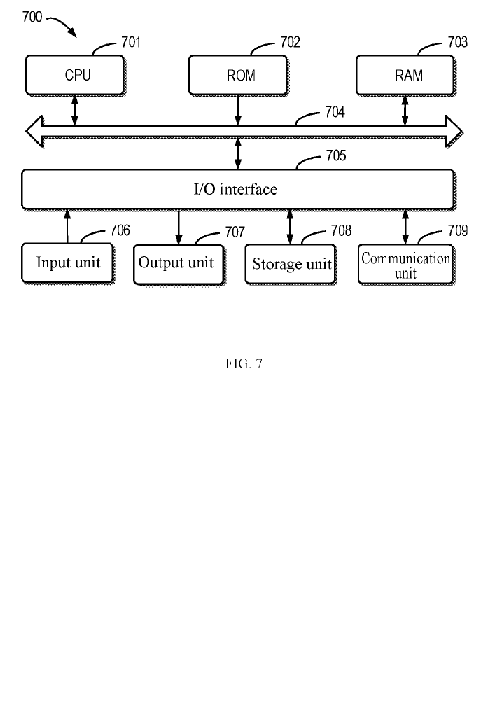

FIG. 7 illustrates a block diagram of a device 700 capable of implementing a plurality of embodiments of the present disclosure. The device 700 may be, for example, the client 102 or the server side 104 shown in FIG. 1.As shown in FIG. 7, the device 700 includes a central processing unit (CPU) and/or a graphics processing unit (GPU) 701, which may perform various suitable actions and processing according to computer program instructions stored in a read-only memory (ROM) 702 or computer program instructions loaded from a storage unit 708 into a random access memory (RAM) 703.The RAM 703 may also store various programs and data required for the operation of the device 700.The CPU/GPU 701, the ROM 702, and the RAM 703 are connected to one another through a bus 704.An input/output (I/O) interface 705 is also connected to the bus 704.Although not shown in FIG. 7, the device 700 may also include a coprocessor.

A plurality of components in the device 700 are connected to the I/O interface 705, including an input unit 706 such as a keyboard and a mouse; an output unit 707 such as various types of displays and speakers; the storage unit 708 such as a disk and an optical disk; and a communication unit 709 such as a network card, a modem, and a wireless communication transceiver. The communication unit 709 allows the device 700 to exchange information/data with other devices through a computer network such as the Internet, and/or various telecommunication networks.

The various methods or processes described above may be performed by the CPU/GPU 701.For example, in some embodiments, the method may be implemented as a computer software program that is tangibly included in a machine-readable medium, such as the storage unit 708.In some embodiments, part or all of the computer program may be loaded and/or installed onto the device 700 via the ROM 702 and/or the communication unit 709.When the computer program is loaded onto the RAM 703 and executed by the CPU/GPU 701, one or more of steps or actions of the methods or the processes described above may be performed.

In some embodiments, the methods and the processes described above may be implemented as a computer program product. The computer program product may include a computer-readable storage medium carrying computer-readable program instructions for performing various aspects of the present disclosure.

The computer-readable storage medium may be a tangible device that may retain and store instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard drive, a random access memory (RAM), a read-only memory (ROM), an erasable programmable read-only memory (EPROM or a flash memory), a static random access memory (SRAM), a portable compact disk read-only memory (CD-ROM), a digital versatile disc (DVD), a memory stick, a floppy disk, a mechanical encoding device, such as a punch card or a raised structure in a groove with instructions stored therein, and any suitable combination of the above. The computer-readable storage medium used herein is not to be interpreted as transient signals, such as radio waves or other freely propagating electromagnetic waves, electromagnetic waves propagated through waveguides or other transmission media (e.g., light pulses through fiber-optic cables), or electrical signals transmitted through wires.

The computer-readable program instructions described herein may be downloaded from the computer-readable storage medium to various computing/processing devices or downloaded to an external computer or an external storage device through a network, such as the Internet, a local area network, a wide area network, and/or a wireless network. The network may include a copper transmission cable, fiber optic transmission, wireless transmission, a router, a firewall, a switch, a gateway computer, and/or an edge server. A network adapter card or a network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, where the programming languages include object-oriented programming languages and conventional procedural programming languages. The computer-readable program instructions may be executed entirely on a user computer, partly on the user computer, as a stand-alone software package, partly on the user computer and partly on a remote computer, or entirely on the remote computer or the server. In the case of the remote computer, the remote computer may be connected to the user computer through any type of network, including a local area network (LAN) or a wide area network (WAN), or may be connected to the external computer (e.g., connected through the Internet with the aid of an Internet service provider).In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or other programmable data processing apparatus, thereby producing a machine, such that these instructions, when executed by the processing unit of the computer or other programmable data processing apparatus, produce an apparatus for implementing functions/actions specified in one or more blocks in the flowcharts and/or the block diagrams. These computer-readable program instructions may also be stored in the computer-readable storage medium, and these instructions cause the computer, the programmable data processing apparatus, and/or other device to operate in a specific method; and therefore, the computer-readable medium having instructions stored therein includes a product that includes instructions for implementing various aspects of the functions/actions specified in one or more blocks in the flowcharts and/or the block diagrams.

The computer-readable program instructions may also be loaded to the computer, other programmable data processing apparatus, or other device, such that a series of operating steps are performed on the computer, other programmable data processing apparatus, or other device to produce a computer-implemented process, and accordingly, the instructions executed on the computer, other programmable data processing apparatus, or other device implement the functions/actions specified in one or more blocks in the flowcharts and/or the block diagrams.

The flowcharts and the block diagrams in the accompanying drawings illustrate the possibly implemented system architectures, functions, and operations of the device, the method, and the computer program product according to the plurality of embodiments of the present disclosure. In this regard, each block in the flowcharts or the block diagrams may represent a module, a program segment, or a portion of instruction, and the module, the program segment, or the portion of instruction includes one or more executable instructions for implementing specified logical functions. In some alternative implementations, functions marked in the blocks may also occur in an order different from that marked in the accompanying drawings. For example, two successive blocks may actually be executed in parallel substantially, and sometimes may also be executed in a reverse order, depending on functions involved. It should be further noted that each block in the block diagrams and/or the flowcharts, as well as a combination of the blocks in the block diagrams and/or the flowcharts may be implemented by using a dedicated hardware-based system that executes specified functions or actions, or using a combination of dedicated hardware and computer instructions.

The embodiments of the present disclosure have been described above. The above description is exemplary, rather than exhaustive, and is not limited to the disclosed various embodiments. Numerous modifications and variations are apparent to those of ordinary skill in the art without departing from the scope and spirit of the described embodiments. The selection of the terms as used herein is intended to best explain the principles and practical applications of the various embodiments, or improvements to technologies on the market, or to allow other persons of ordinary skill in the art to understand the various embodiments disclosed herein.

We claim:

1. A method for processing a log, comprising:
classifying, in response to an event recorded into the log being triggered, the event into a target event category by a client;
acquiring, in response to determining that a log analysis task is triggered, a plurality of events with the target event category by the client;
generating event aggregation data by the client based on the plurality of events; and
uploading the event aggregation data from the client to a server side.

2. The method according to claim 1, wherein the event is stored in a storage area located on the client, the storage area of the client is configured to store an event stream based on a time sequence, the event stored in the storage area comprises trigger time of the event, a type of the event, and content of the event, and acquiring the plurality of events with the target event category by the client comprises:
acquiring the plurality of events from the event stream stored in the storage area.

3. The method according to claim 2, further comprising:
determining a time difference between the trigger time of the event and current time; and
deleting, in response to the time difference being greater than a predetermined retention time threshold, the event from the storage area of the client.

4. The method according to claim 1, wherein the event is a first event, and determining that the log analysis task is triggered comprises:
determining that a second event is triggered;
determining, in response to determining that the trigger of the second event meets a preset trigger condition for the log analysis task, that the log analysis task is triggered.

5. The method according to claim 1, wherein generating the event aggregation data by the client based on the plurality of events comprises:
acquiring an aggregation strategy for the log analysis task; and
generating the event aggregation data by applying the aggregation strategy to the plurality of events.

6. The method according to claim 5, wherein acquiring the aggregation strategy for the log analysis task comprises:
acquiring the aggregation strategy for the log analysis task from the server side, wherein the aggregation strategy is configured by a user in real time at the server side.

7. The method according to claim 1, wherein generating the event aggregation data by the client based on the plurality of events comprises:
determining a resource utilization rate of the client; and
generating the event aggregation data based on the plurality of events in response to determining that the resource utilization rate is less than a preset resource utilization rate threshold.

8. The method according to claim 1, wherein uploading the event aggregation data to the server side comprises:
recognizing target data with a specific type from the event aggregation data;
generating processed event aggregation data by deleting or replacing the target data; and
uploading the processed event aggregation data to the server side.

9. The method according to claim 8, wherein recognizing target data with the specific type from the event aggregation data comprises:
recognizing potential target data from the event aggregation data by using a natural language processing model; and
determining that the potential target data is the target data with the specific type by using a regular expression.

10. The method according to claim 1, wherein uploading the event aggregation data to the server side comprises:
uploading, in response to receiving a log upload request from the server side, the event aggregation data to the server side, wherein the log upload request is sent by the server side to the client after receiving feedback from a user regarding a fault or defect.

11. An electronic device, comprising:
a processor; and
a memory coupled with the processor, the memory having instructions stored therein, and the instructions, when executed by the processor, causing the electronic device to:
classify, in response to an event recorded into the log being triggered, the event into a target event category by a client;
acquire, in response to determining that a log analysis task is triggered, a plurality of events with the target event category by the client;
generate event aggregation data by the client based on the plurality of events; and
upload the event aggregation data from the client to a server side.

12. The electronic device according to claim 11, wherein the event is stored in a storage area located on the client, the storage area of the client is configured to store an event stream based on a time sequence, the event stored in the storage area comprises trigger time of the event, a type of the event, and content of the event, and the instructions to acquire the plurality of events with the target event category by the client comprise instructions to:
acquire the plurality of events from the event stream stored in the storage area.

13. The electronic device according to claim 12, further comprising instructions to:
determine a time difference between the trigger time of the event and current time; and
delete, in response to the time difference being greater than a predetermined retention time threshold, the event from the storage area of the client.

14. The electronic device according to claim 11, wherein the event is a first event, and the instructions to determine that the log analysis task is triggered comprise instructions to:
determine that a second event is triggered;
determine, in response to determining that the trigger of the second event meets a preset trigger condition for the log analysis task, that the log analysis task is triggered.

15. The electronic device according to claim 11, wherein the instructions to generate the event aggregation data by the client based on the plurality of events comprise instructions to:
acquire an aggregation strategy for the log analysis task; and
generate the event aggregation data by applying the aggregation strategy to the plurality of events.

16. The electronic device according to claim 15, wherein the instructions to acquire the aggregation strategy for the log analysis task comprise instructions to:
acquire the aggregation strategy for the log analysis task from the server side, wherein the aggregation strategy is configured by a user in real time at the server side.

17. The electronic device according to claim 11, wherein the instructions to generate the event aggregation data by the client based on the plurality of events comprise instructions to:
determine a resource utilization rate of the client; and
generate the event aggregation data based on the plurality of events in response to determining that the resource utilization rate is less than a preset resource utilization rate threshold.

18. The electronic device according to claim 11, wherein the instructions upload the event aggregation data to the server side comprise instructions to:
recognize target data with a specific type from the event aggregation data;
generate processed event aggregation data by deleting or replacing the target data; and
upload the processed event aggregation data to the server side.

19. The electronic device according to claim 18, wherein the instructions to recognize target data with the specific type from the event aggregation data comprises:
recognize potential target data from the event aggregation data by using a natural language processing model; and
determine that the potential target data is the target data with the specific type by using a regular expression.

20. A computer program product, wherein the computer program product is tangibly stored on a non-transitory computer-readable medium and comprises machine-executable instructions, and the machine-executable instructions, when executed, causes a machine to:
classify, in response to an event recorded into the log being triggered, the event into a target event category by a client;
acquire, in response to determining that a log analysis task is triggered, a plurality of events with the target event category by the client;
generate event aggregation data by the client based on the plurality of events; and
upload the event aggregation data from the client to a server side.
